(19) United States
(12) Patent Application Publication
(10) Pub. No.: US 2026/0316169 A1
(43) Pub. Date: Oct. 15, 2026

(54) METHOD OF FORMING LUBRICATING WAVES ON SCREW SURFACE OF TRAPEZOIDAL SCREW

(71) Applicant: Dongil Machinery Co., Ltd., Anseong-si (KR)

(72) Inventors: Jang Sik PARK, Seongnam-si (KR); Ji Hun PARK, Seongnam-si (KR); Eun Uk KIM, Anseong-si (KR); Kyung Min KIM, Anseong-si (KR)

(21) Appl. No.: 19/561,401

(22) Filed: Mar. 9, 2026

(30) Foreign Application Priority Data
Apr. 14, 2025 (KR) 10-2025-0048053

(51) Int. Cl. B23D 5/02

(52) U.S. Cl. CPC B23D 5/02

(57) ABSTRACT

A method of forming lubricating waves on a screw surface of a trapezoidal screw, in which a lubrication operation may be smoothly performed even under a high applied load by forming, on a screw surface of a trapezoidal screw, regular waves on which a lubricant may remain. The method includes: preparing a trapezoidal screw; forming forming waves on an outer circumferential surface of a forming wheel by adjusting a cutting depth and a cutting pitch using a cutting tool while rotating the forming wheel; and forming regular lubricating waves on the screw surface of the trapezoidal screw using the forming wheel, by rotating the forming wheel at a speed faster than a rotational speed of the trapezoidal screw while being externally tangent to the trapezoidal screw, thereby reducing generation of excessive frictional sound or abrasion and simultaneously making waves evenly distributed on the screw surface of the trapezoidal screw so that the lubrication operation may be performed evenly across the entire screw surface.

### CROSS-REFERENCE TO RELATED PATENT APPLICATIONS

This application claims the benefit of Korean Patent Application No. 10-2025-0048053, filed on Apr. 14, 2025, in the Ministry of Intellectual Property, Republic of Korea, the disclosure of which is incorporated herein in its entirety by reference.

### BACKGROUND

### 1. Field

The disclosure relates to a method of forming lubricating waves on a screw surface of a trapezoidal screw, and more particularly, to a method of forming lubricating waves on a screw surface of a trapezoidal screw, in which a lubrication operation may be smoothly performed even under a high applied load by forming, on a screw surface of a trapezoidal screw, regular waves on which a lubricant may remain, thereby reducing generation of excessive frictional sound or abrasion and simultaneously making waves evenly distributed on the screw surface of the trapezoidal screw so that the lubrication operation may be performed evenly across the entire screw surface.

### 2. Description of the Related Art

In general, a screw collectively refers to a mechanical component having a helical groove formed along a long shaft, and constitutes one of the most common mechanical connection methods.

Such screws are classified, according to the shape of the thread, into triangular threads, round threads, square threads, trapezoidal threads, and the like. Among these threads, a trapezoidal thread has a trapezoidal thread profile and has been widely used because the trapezoidal thread is relatively easy to machine.

In particular, since a trapezoidal thread is capable of transmitting a large axial force, the trapezoidal thread is not limited to fastening between mechanical elements, but is also used in various mechanical elements that convert rotational motion into linear motion. Korean Patent Registration No. 10-2238238 and the like discloses the trapezoidal thread.

FIG. 1 is a cross-sectional view illustrating a general trapezoidal screw and a spindle nut. As illustrated in FIG. 1, when a trapezoidal screw 10 and a spindle nut 20 are fastened to each other, the spindle nut 20 may move to the left and right on the drawing by rotating the trapezoidal screw 10 while restricting the rotation of the spindle nut 20.

In other words, rotational motion may be converted into linear motion.

Reversely, when the spindle nut 20 is rotated while the rotation of the trapezoidal screw 10 is restricted, it may be possible to move the trapezoidal screw 10 to the left and right on the drawing.

FIG. 2 is an enlarged view of a region A in FIG. 1. As illustrated in FIG. 2, the screw thread of the trapezoidal screw 10 has a trapezoidal shape so that control precision is high, and even under a high operating load, transfer of the spindle nut 20 is possible during the rotation of the trapezoidal screw 10, and thus the trapezoidal screw 10 has been applied to, for example, a rear-wheel steering apparatus of a vehicle.

According to the related art, a frictional force generated between the trapezoidal screw 10 and the spindle nut 20 may be reduced by supplying a lubricant such as grease to a fastening portion between the trapezoidal screw 10 and the spindle nut 20.

FIG. 3 is an enlarged view of a region B in FIG. 2. As illustrated in FIG. 3, a lubricant is supplied between screw surfaces of the trapezoidal screw 10 and the spindle nut 20 so as to form an oil film, and thus a frictional force between these components may be reduced.

However, when the trapezoidal screw 10 and the spindle nut 20 are in close contact with each other due to a high pressure by the high operating load, it may be a problem that the oil film of the lubricant is not formed between the screw surfaces in close contact with each other.

As such, according to the related art, it has been a problem that when the oil film of the lubricant is not formed on the screw surfaces between the trapezoidal screw 10 and the spindle nut 20, due to the high contact pressure, a loud frictional sound and abrasion are generated from the screw surfaces where the trapezoidal screw 10 and the spindle nut 20 are in contact with each other.

### PRIOR ART DOCUMENT

### Patent Literature

(Patent Literature 1) Korean Patent Publication No. 10-2238238

### SUMMARY

Provided is a method of forming lubricating waves on a screw surface of a trapezoidal screw, which may reduce generation of excessive frictional sound or abrasion as a lubrication operation is performed even when a trapezoidal screw transfers power under a high operating load and simultaneously make waves evenly distributed on the screw surface of the trapezoidal screw so that the lubrication operation may be performed evenly across the entire screw surface.

According to an aspect of the disclosure, a method of forming lubricating waves on a screw surface of a trapezoidal screw includes: preparing the trapezoidal screw; forming forming waves on an outer circumferential surface of a forming wheel by adjusting a cutting depth and a cutting pitch using a cutting tool while rotating the forming wheel; and forming regular lubricating waves on the screw surface of the trapezoidal screw using the forming wheel, by rotating the forming wheel at a speed faster than a rotational speed of the trapezoidal screw while being externally tangent to the trapezoidal screw.

In the forming of the regular lubricating waves, the lubricating waves formed on the trapezoidal screw may have a pitch of 170-190 μm.

In the forming of the regular lubricating waves, the lubricating waves formed on the trapezoidal screw may have a depth of 2.5-3.5 μm.

Furthermore, the trapezoidal screw according to an embodiment having a screw surface on which lubricating waves are formed may be manufactured by the method described above.

In addition, a rear-wheel steering apparatus of a vehicle may include the trapezoidal screw described above.

### BRIEF DESCRIPTION OF THE DRAWINGS

Exemplary embodiments of the disclosure will be more clearly understood from the following detailed description taken in conjunction with the accompanying drawings in which:

FIG. 1 is a cross-sectional view illustrating a general trapezoidal screw and a spindle nut;

FIG. 2 is an enlarged view of a region A in FIG. 1;

FIG. 3 is an enlarged view of a region B in FIG. 2;

FIG. 4 is a flowchart illustrating a method of forming lubricating waves on a screw surface of a trapezoidal screw, according to an embodiment;

FIG. 5 is a diagram illustrating a process of a second operation in a method of forming lubricating waves on a screw surface of a trapezoidal screw, according to an embodiment;

FIG. 6 is a diagram illustrating a process of a third operation in a method of forming lubricating waves on a screw surface of a trapezoidal screw, according to an embodiment;

FIG. 7 is an enlarged a cross-sectional view illustrating a trapezoidal screw according to an embodiment, in which lubricating waves are formed on a screw surface,, and a screw surface of a spindle nut; and

FIG. 8A and FIG. 8B is a comparison diagram of a trapezoidal screw according to an embodiment, in which lubricating waves are formed on a screw surface, and a trapezoidal screw according to the related art.

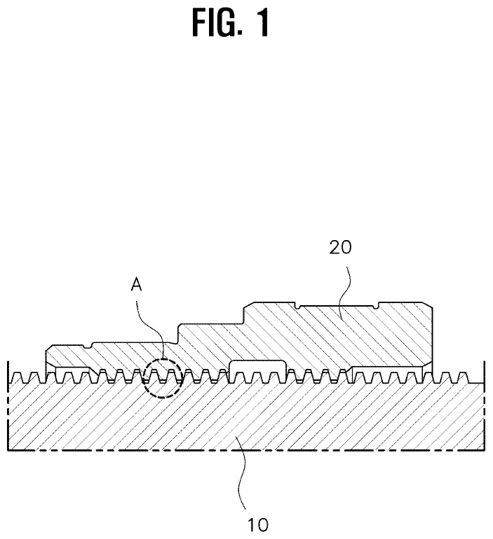

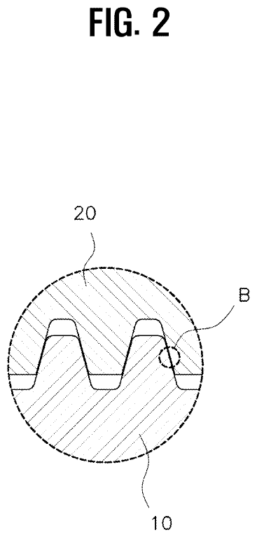

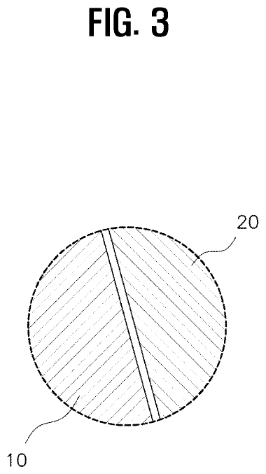

### DETAILED DESCRIPTION OF THE EXEMPLARY EMBODIMENTS

Embodiments of the disclosure are described in detail with reference to the accompanying drawings. However, the disclosure is not limited thereto and it will be understood that various changes in form and details may be made therein without departing from the spirit and scope of the following claims. That is, descriptions on particular structures or functions may be presented merely for explaining embodiments of the disclosure.

As the disclosure allows for various changes and numerous embodiments, embodiments will be illustrated in the drawings and described in detail in the written description. Throughout the drawings, like reference numerals denote like elements.

Terms such as “first” and “second” are used herein merely to describe a variety of constituent elements, but the constituent elements are not limited by the terms. Such terms are used only for the purpose of distinguishing one constituent element from another constituent element. For example, without departing from the right scope of the disclosure, a first constituent element may be referred to as a second constituent element, and vice versa.

In the specification, when a constituent element “connects” or is “connected” to another constituent element, the constituent element contacts or is connected to the other constituent element directly or through at least one of other constituent elements. Conversely, when a constituent element is described to “directly connect” or to be “directly connected” to another constituent element, the constituent element should be construed to be directly connected to another constituent element without any other constituent element interposed therebetween. Other expressions, such as, “between” and “directly between,” describing the relationship between the constituent elements, may be construed in the same manner.

Terms used in the specification are used for explaining a specific embodiment, not for limiting the disclosure. Thus, an expression used in a singular form in the specification also includes the expression in its plural form unless clearly specified otherwise in context. Also, terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

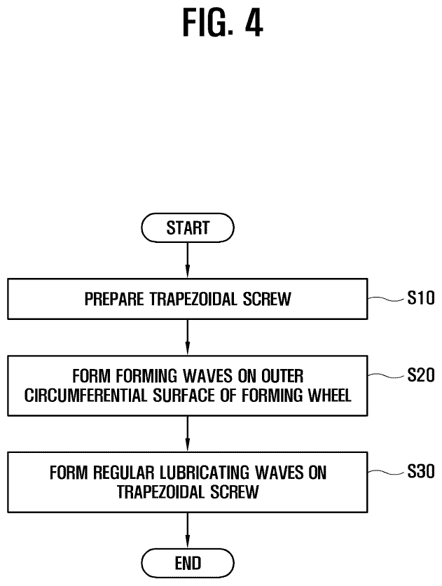

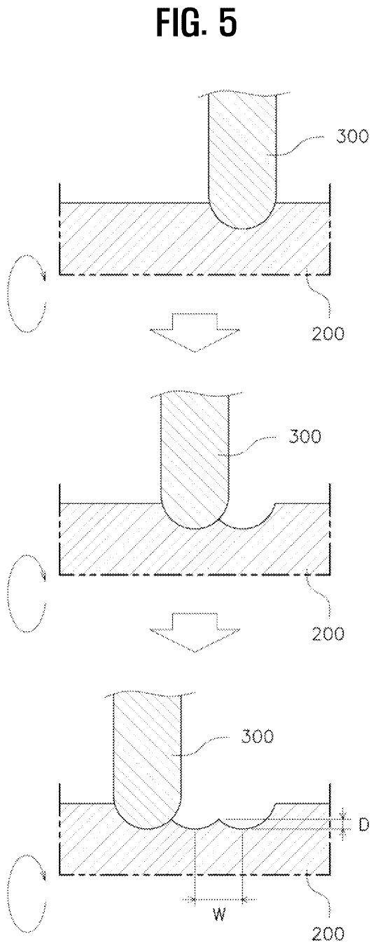

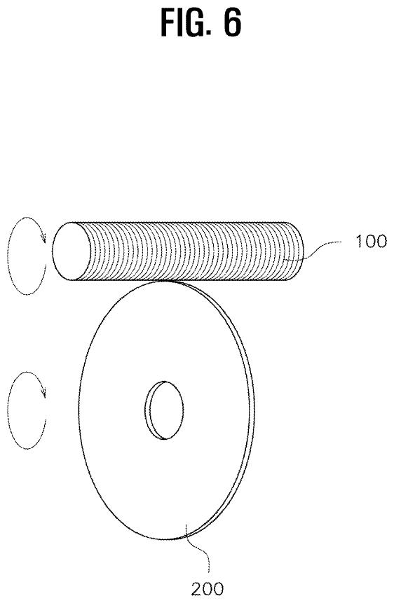

FIG. 4 is a flowchart illustrating a method of forming lubricating waves on a screw surface of a trapezoidal screw, according to an embodiment. FIG. 5 is a diagram illustrating a process of a second operation in a method of forming lubricating waves on a screw surface of a trapezoidal screw, according to an embodiment. FIG. 6 is a diagram illustrating a process of a third operation in a method of forming lubricating waves on a screw surface of a trapezoidal screw, according to an embodiment.

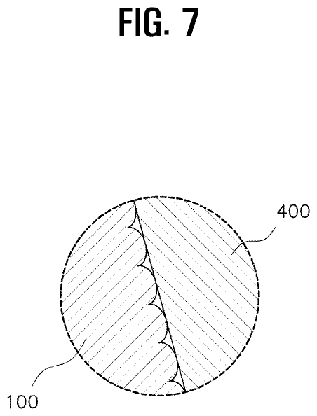

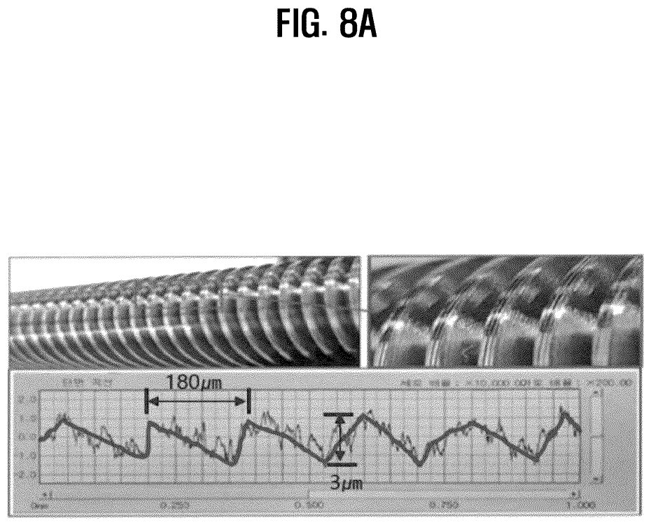

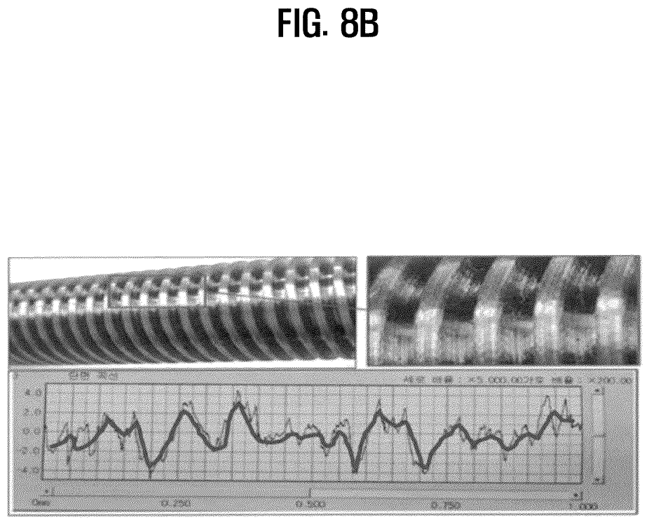

FIG. 7 is an enlarged a cross-sectional view illustrating a trapezoidal screw according to an embodiment, in which lubricating waves are formed on a screw surface, and a screw surface of a spindle nut. FIG. 8A and FIG. 8B is a comparison diagram of a trapezoidal screw according to an embodiment, in which lubricating waves are formed on a screw surface, and a trapezoidal screw according to the related art, in which FIG. 8A illustrates a trapezoidal screw according to an embodiment, and FIG. 8B illustrates a trapezoidal screw according to the related art.

It may be core technical features of a method of forming lubricating waves on a screw surface of a trapezoidal screw, according to an embodiment, to enable a lubrication operation even when the trapezoidal screw transfer power under a high operating load, thereby reducing generation of excessive frictional sound or abrasion, and simultaneously, making waves evenly distributed on the screw surface of the trapezoidal screw so that the lubrication operation may be performed evenly across the entire screw surface.

The method of forming lubricating waves on a screw surface of a trapezoidal screw, according to an embodiment, will be described in detail with reference to the accompanying drawings.

The method of forming lubricating waves on a screw surface of a trapezoidal screw, according to an embodiment, as illustrated in FIGS. 4 to 6, may include: preparing a trapezoidal screw 100 (S10); forming forming waves on an outer circumferential surface of a forming wheel 200 by adjusting a cutting depth and a cutting pitch using a cutting tool 300 while rotating the forming wheel 200 (S20); and forming regular lubricating waves on a screw surface of the trapezoidal screw 100 by using the forming wheel 200 while rotating the trapezoidal screw 100 and the forming wheel 200, the forming wheel 200 rotating faster than a rotational speed of the trapezoidal screw 100 and being externally tangent to the trapezoidal screw 100 (S30).

In other words, the method of forming lubricating waves on a screw surface of a trapezoidal screw, according to an embodiment, may largely include preparing the trapezoidal screw 100 (S10), forming forming waves on the outer circumferential surface of the forming wheel 200 (S20), and forming regular lubricating waves on the screw surface of the trapezoidal screw 100 (S30).

First, in the operation S10, the trapezoidal screw 100 is prepared.

The trapezoidal screw 100 has a screw thread having a trapezoidal shape so as to have high control precision and enable transfer of a spindle nut 400 during rotation under a high operating load.

For example, it may be possible to prepare the trapezoidal screw 100 by machining a screw thread having a trapezoidal shape using a lathe dedicated to screw cutting.

In other words, in the operation S10, the trapezoidal screw 100 may be prepared by using a well-known screw machining method.

Next, in the operation S20, as illustrated in FIG. 5, while rotating the forming wheel 200 at a certain speed, forming waves are machined on the outer circumferential surface of the forming wheel 200.

Here, the forming wheel 200 has an approximately disc shape having a diameter greater than the trapezoidal screw 100 prepared in the operation S10.

In this state, the machining of the forming waves may be performed by using a separate cutting tool 300. The forming waves are appropriately machined by adjusting a cutting depth and as cutting pitch of the cutting tool 300.

In particular, the outer circumferential shape of the forming wheel 200 may be roughly similar to the shape of the screw thread of the trapezoidal screw 100.

Referring to FIG. 5, as shown in the upper side of FIG. 5, a first wave of the forming waves may be machined on the forming wheel 200 by using the cutting tool 300, and after the forming wheel 200 rotates once, as shown in the middle side of FIG. 5, a second wave of the forming waves may be machined on the forming wheel 200.

By repeating the above operations, as shown in the lower side of FIG. 5, a third wave and subsequent waves of the forming waves may be sequentially machined on the forming wheel 200, and as a result, the forming waves may be machined on the outer circumferential surface of the forming wheel 200.

As such, the forming waves formed on the outer circumferential surface of the forming wheel 200 may be formed to be concave in a wave pattern on the forming wheel 200.

Next, in the operation S30, as illustrated in FIG. 6, the trapezoidal screw 100 is located at the center and rotated, and the forming wheel 200 is rotated while being externally tangent to the trapezoidal screw 100, and thus regular lubricating waves are formed on the screw surface of the trapezoidal screw 100.

In this state, the rotational speed of the forming wheel 200 may be set to be faster than the rotational speed of the trapezoidal screw 100. In this state, the rotational axis of the forming wheel 200 may be inclined by an angel of the screw surface of the trapezoidal screw 100 with respect to the rotational axis of the trapezoidal screw 100.

Accordingly, the forming wheel 200 may form regular lubricating waves on the screw surface of the trapezoidal screw 100.

As such, the regular lubricating waves formed on the screw surface of the trapezoidal screw 100 may allow a lubricant such as grease to remain in a valley between substantially convex arc shapes as illustrated in FIG. 7.

A trapezoidal screw having a screw surface on which lubricating waves are formed is manufactured by using the method of forming lubricating waves on a screw surface of a trapezoidal screw, according to an embodiment, configured as above.

FIG. 8A illustrates an image capturing the trapezoidal screw in which the lubricating waves are formed on the screw surface, which is manufactured as described above. In this state, it can be checked that an interval W and a depth D of the lubricating waves formed on the trapezoidal screw 100 are uniform across the entire length of the trapezoidal screw 100.

In contrast, when grinding machining is performed in a state in which a grinder with coarse particles is simply externally tangent to the trapezoidal screw 100, as shown in FIG. 8B, although scratches are formed in a similar pattern to the lubricating waves according to the present embodiment, it can be checked that such scratches do not have a uniform pitch or depth across the entire length of the trapezoidal screw 100.

In other words, it is impossible, by forming scratches on the trapezoidal screw 100 using a grinder alone, to form uniform lubricating waves which may be obtained from the trapezoidal screw according to the present embodiment in which lubricating waves are formed on the screw surface.

In addition, in the present embodiment, the interval W and the depth D of the lubricating waves formed on the trapezoidal screw 100 may be formed as the interval W and the depth D of desired lubricating waves by merely adjusting the cutting depth and cutting pitch of the cutting tool 300 in the operation S20 of the above-described method of forming lubricating waves on a screw surface of a trapezoidal screw, according to an embodiment.

The present applicant has tested lubrication characteristics by repeatedly manufacturing the trapezoidal screw 100 while diversely changing the interval W and the depth D of the lubricating waves formed on the screw surface of the trapezoidal screw 100.

As a result, in the present embodiment described above, it can be checked that desirable lubrication characteristics are obtained when, in the operation S30, the lubricating waves formed on the trapezoidal screw have an interval W of 170-190 μm and a depth D of 2.5-3.5 μm.

In other words, while the trapezoidal screw 100 and the spindle nut 400 are fastened to each other, even when the trapezoidal screw 100 and the spindle nut 400 are in close contact with each other due to a high pressure by a high operating load, a lubricant such as grease constantly remains within the lubricating waves between closely contacting screw surfaces, thereby enabling formation of an oil film of the lubricant.

Accordingly, the generation of loud frictional sound and abrasion on the screw surface where the trapezoidal screw 100 and the spindle nut 400 are in contact with each other with a high pressure may be effectively prevented.

It may be the technical feature of the disclosure to manufacture, by the method described above, the trapezoidal screw according to the present embodiment in which lubricating waves are formed on a screw surface.

As such, the trapezoidal screw according to the present embodiment, in which lubricating waves are formed on a screw surface and which has high control precision and enables transfer of the spindle nut 400 during rotation of the trapezoidal screw 100 even under a high operating load, may be applied to a rear-wheel steering apparatus of a vehicle.

In other words, it may be the technical feature of the disclosure that the rear-wheel steering apparatus of a vehicle includes the above-described trapezoidal screw having a screw surface on which lubricating waves are formed.

The method of forming lubricating waves on the screw surface of the trapezoidal screw as described above may enable a lubrication operation even when the trapezoidal screw transfers power under a high operating load, thereby reducing generation of excessive frictional sound or abrasion, and simultaneously, making waves evenly distributed on the screw surface of the trapezoidal screw so that the lubrication operation may be performed evenly across the entire screw surface.

As such, while this disclosure has been particularly shown and described with reference to embodiments thereof, it will be understood by those of ordinary skill in the art that various changes in form and details may be made therein without departing from the spirit and scope of the disclosure as defined by the appended claims.

The embodiments should be considered in descriptive sense only and not for purposes of limitation. Therefore, the scope of the disclosure is defined not by the detailed description of the disclosure but by the appended claims, and all differences within the scope will be construed as being included in the disclosure.

What is claimed is:

1. A method of forming lubricating waves on a screw surface of a trapezoidal screw, the method comprising:
preparing the trapezoidal screw;
forming forming waves on an outer circumferential surface of a forming wheel by adjusting a cutting depth and a cutting pitch using a cutting tool while rotating the forming wheel; and
forming regular lubricating waves on the screw surface of the trapezoidal screw using the forming wheel, by rotating the forming wheel at a speed faster than a rotational speed of the trapezoidal screw while being externally tangent to the trapezoidal screw.

2. The method of claim 1, wherein, in the forming of the regular lubricating waves, the lubricating waves formed on the trapezoidal screw have an interval (W) of 170-190 μm.

3. The method of claim 2, wherein, in the forming of the regular lubricating waves, the lubricating waves formed on the trapezoidal screw have a depth (D) of 2.5-3.5 μm.

4. A trapezoidal screw having a screw surface on which lubricating waves are formed, the trapezoidal screw being manufactured according to the method of claim 1.

5. A rear-wheel steering apparatus of a vehicle, the rear-wheel steering apparatus comprising the trapezoidal screw according to claim 4.
